(19) United States
(12) Patent Application Publication
(10) Pub. No.: US 2002/0015029 A1
(43) Pub. Date: Feb. 7, 2002

(54) On-screen display device

(76) Inventors: Toru Mizushima, Toyonaka-shi (JP); Yasuhiko Tomikawa, Kita-ku (JP)

Correspondence Address: PARKHURST & WENDEL, L.L.P., Suite 210, 1421 Prince Street, Alexandria, VA, 22314-2805, US

(21) Appl. No.: 09/894,891

(22) Filed: Jun. 29, 2001

(30) Foreign Application Priority Data
Jun. 29, 2000 (JP) 2000-196078

(51) Int. Cl. G09G 5/00

(52) U.S. Cl. 345/204

(57) ABSTRACT

An on-screen display device comprises a video signal generation circuit for generating a video signal including an information signal for displaying information on a display screen, a horizontal sync signal, and a color burst signal; a signal conversion circuit for compressing the amplitude of an input signal so that the input signal can exist at a level higher than the level of the horizontal sync signal, and shifting the level of the input signal so that the input signal can exist at a level hither than the level of the horizontal sync signal, thereby generating a first signal; and an output control circuit for outputting the video signal when the information signal is displayed on the display screen, and outputting the first signal when the information signal is not displayed. Therefore, the amplitude level of an external input signal is prevented from becoming lower than the pedestal level, whereby information such as characters can be reliably superimposed on a noise signal.

### FIELD OF THE INVENTION

The present invention relates to an on-screen display device and, more particularly, to an on-screen display device for superimposing characters or graphics on a video signal supplied from the outside, or generating a video signal for displaying characters or graphics.

### BACKGROUND OF THE INVENTION

In recent years, from the viewpoint of user interface, video equipment has been provided with, as an indispensable constituent, an on-screen display (hereinafter referred to as OSD) device for superimposing an information signal of characters, graphics, or the like on a video signal for display. For example, a user can change, set, or reserve a program while displaying information such as channel information, menu panel, or the like on a display screen of video equipment.

Hereinafter, a conventional OSD device will be described.

FIG. 6 is a block diagram for explaining the construction of a conventional OSD device 50, and the OSD device 50 will be described for the case where a video source is a broadcast wave or a VTR tape.

With reference to FIG. 6, a video processing circuit 51 receives a video signal supplied from a tuner 52 or a video signal recorded on a VTR tape 53, and outputs a composite video signal or a SVHS video signal (a luminance signal and a chroma signal). The OSD device 50 is provided with an OSD signal generation circuit 11 and two switches (ASW1 and ASW2). The OSD signal generation circuit 11 generates an information signal to be superimposed on a video signal supplied from an input terminal E1, or generates a video signal including an information signal. An OSD signal switch (ASW2) receives the information signal or the video signal generated by the OSD signal generation circuit 11, and outputs it to an output terminal E2. An input video signal through switch (ASW1) receives the video signal from the input terminal E1, and outputs it to the output terminal E2.

Next, the operation of the OSD device 50 so constructed will be described with reference to FIGS. 6 and 7(a)-7(e).

FIGS. 7(a)-7(e) are diagrams for explaining the operation of the conventional OSD device. To be specific, FIG. 7(a) shows an example of an on-screen display, wherein a background image 62 corresponding to a video signal and an OSD image 61 corresponding to an information signal are displayed. FIG. 7(b) shows an input video signal inputted to the input terminal E1, FIG. 7(c) shows an output video signal outputted from the output terminal E2, FIG. 7(d) shows the ON/OFF operation of the switch ASW1, and FIG. 7(e) shows the ON/OFF operation of the switch ASW2.

First of all, a description will be given of the operations of the switches ASW1 and ASW2 to display the OSD image, on the basis of a scanning line shown in FIG. 7(a).

A period a2 during which the OSD image 61 is displayed on the screen shown in FIG. 7(a) (hereinafter, referred to as OSD display period), and a period a1 or a3 during which the background image 62 is displayed on the screen (hereinafter, referred to as video display period) will be described separately.

In the video display period (a1 or a3), the switch ASW1 is ON, and the switch ASW1 receives the input video signal (FIG. 7(b)) supplied from the input terminal E1, and outputs it to the output terminal E2. On the other hand, in the OSD display period (a2), the switch ASW2 is ON, and the switch ASW2 receives the information signal generated by the OSD signal generation circuit 11, and outputs it to the output terminal E2. That is, the output terminal E2 outputs the video signal (FIG. 7(c)) in which the information signal is superimposed on the video signal.

Although, in the above-described operation, the OSD device 50 superimposes the information signal on the video signal supplied from the outside (hereinafter, referred to as external synchronous OSD), the OSD device 50 may generate a video signal including a horizontal sync signal and a color burst signal, and superimpose an information signal on the video signal (hereinafter, referred to as internal synchronous OSD). In this case, the switch ASW2 is kept in the ON state, and the switch ASW1 is kept in the OFF state.

In the conventional OSD device, however, if a weak-electric field having no video signal (i.e., a noise signal) is supplied from the outside when external synchronous OSD is carried out, the level of the input video signal is disordered, whereby the horizontal sync signal cannot be distinguished and, therefore, the information signal cannot be displayed.

There is a character display circuit disclosed in Japanese Published Patent Application No. Hei.8-79646 as an OSD device that solves the above-mentioned problems, and the OSD device will be described with reference to FIGS. 8 and 9(a)-9(g).

FIG. 8 is a block diagram for explaining the conventional OSD device.

With reference to FIG. 8, an OSD device 70 comprises an OSD signal generation circuit 11, a capacitor 71, and switches ASW1, ASW2, and ASW3. The capacitor 71 cuts the DC component of a video signal supplied from an input terminal E1. The switch ASW3 is ON during the video display period, and OFF during the OSD display period. In FIG. 8, the same constituents as those described with respect to FIG. 6 are given the same reference numerals, and description thereof will be omitted.

Next, the operation of the OSD device 70 so constructed will be described with reference to FIGS. 9(a)-9(g).

FIGS. 9(a)-9(g) are diagrams for explaining the operation of the OSD device 70. To be specific, FIG. 9(a) shows an example of an on-screen display, FIG. 9(b) shows an input signal of a weak electric field, inputted to the input terminal E1, FIG. 9(c) shows an internal video signal generated in the OSD device 70, FIG. 9(d) shows an output video signal outputted from the output terminal E2, FIG. 9(e) shows ON/OFF operation of the switch ASW1, FIG. 9(f) shows ON/OFF operation of the switch ASW2, and FIG. 9(g) shows ON/OFF operation of the switch ASW3.

First of all, at the time of external synchronous OSD, if the input video signal is disordered due to the weak electric field as shown in FIG. 9(b) and thereby the horizontal sync signal cannot be distinguished, the OSD image cannot be displayed on the display screen. So, the OSD signal generation circuit 11 generates an internal video signal including a horizontal sync signal, a color burst signal, an information signal (OSD potential), and a gray level, as shown in FIG. 9(c).

When the OSD image and the background image are displayed on the basis of the scanning line shown in FIG. 9(a), the gray level, that is a potential at which the external input signal (FIG. 9(b)) is superimposed, is outputted during the video display period (a1 or a3), and the OSD potential as the information signal is outputted during the OSD display period (a2). At this time, the switch ASW1 is kept in the OFF state, and the switch ASW2 is kept in the ON state. Further, the switch ASW3 is ON during the video display period (a1 or a3), and OFF during the OSD display period (a2). That is, the output terminal E2 outputs an output video signal (FIG. 9(d)) in which the external input signal (FIG. 9(b)) is superimposed on the internal video signal (FIG. 9(c)).

As described above, even when the horizontal sync signal cannot be distinguished because the input video signal is a weak electric field or the like, the OSD device 70 can perform OSD display as well as display of the input video signal, using the internal sync OSD.

In the conventional OSD device, however, depending on the amplitude level of the external input signal inputted to the input terminal E1, the superimposed external input signal becomes lower than the pedestal level in the output video signal. This state is shown in FIGS. 10(a)-10(c).

FIGS. 10(a)-10(c) are diagrams for explaining the case where the external input signal shown in FIG. 9(b) is lower than the pedestal level.

At the time of external synchronous OSD, when the input signal of a weak electric field (noise signal) shown in FIG. 10(a) is superimposed on the internal video signal shown in FIG. 10(b), if the amplitude level of the noise signal is lower than the pedestal level as shown in FIG. 10(c), the noise signal might be recognized as a horizontal sync signal. That is, the position, at which the information signal generated by the OSD signal generation circuit 11 is displayed, is shifted, and characters or graphics cannot be correctly displayed on the display screen.

### SUMMARY OF THE INVENTION

The present invention is made to solve the above-described problems and has for its object to provide an on-screen display device that prevents an external input signal superimposed on an internal video signal from becoming lower than the pedestal level, and reliably displays characters or the like on a noise signal.

Other objects and advantages of the invention will become apparent from the detailed description that follows. The detailed description and specific embodiments described are provided only for illustration since various additions and modifications within the scope of the invention will be apparent to those of skill in the art from the detailed description.

According to a first aspect of the present invention, an on-screen display device comprises: video signal generation means for generating a video signal including an information signal for displaying information on a display screen, a horizontal sync signal, and a color burst signal; signal conversion means for compressing the amplitude of an input signal so that the input signal can exist at a level higher than the level of the horizontal sync signal, and shifting the level of the input signal so that the input signal can exist at a level higher than the level of the horizontal sync signal, thereby generating a first signal; and output control means for outputting the video signal when the information signal is displayed on the display screen, and outputting the first signal when the information signal is not displayed.

According to a second aspect of the present invention, in the on-screen display device of the first aspect, the signal conversion means comprises: signal compression means for compressing the amplitude of the input signal so that the input signal can exist at a level higher than the level of the horizontal sync signal; and level shift means for shifting the level of the input signal so that the input signal can exist at a level higher than the level of the horizontal sync signal.

According to a third aspect of the present invention, an on-screen display device comprises: video signal generation means for generating a video signal including an information signal for displaying information on a display screen, a horizontal sync signal, and a color burst signal; signal compression means for compressing the amplitude of an input signal so that the input signal can exist at a level higher than the level of the horizontal sync signal, thereby generating a first signal; and output control means for outputting the video signal when the information signal is displayed on the display screen, and outputting the first signal when the information signal is not displayed.

According to a fourth aspect of the present invention, an on-screen display device comprises: video signal generation means for generating a video signal including an information signal for displaying information on a display screen, a horizontal sync signal, and a color burst signal; level shift means for shifting the level of the input signal so that the input signal can exist at a level higher than the level of the horizontal sync signal, thereby generating a first signal; and output control means for outputting the video signal when the information signal is displayed on the display screen, and outputting the first signal when the information signal is not displayed.

### BRIEF DESCRIPTION OF THE DRAWINGS

FIG. 1 is a block diagram for explaining an OSD device according to a first embodiment of the present invention.

FIG. 2 is a diagram illustrating the level of an NTSC signal.

FIGS. 3(a)-3(g) are diagrams for explaining the operation of the OSD device according to the first embodiment.

FIG. 4 is a diagram illustrating an amplitude compression/level shift circuit that is included in the OSD device according to the first embodiment.

FIG. 5 is a diagram for explaining an external input signal and a signal after amplitude compression and level shifting, according to the first embodiment.

FIG. 6 is a block diagram for explaining the construction of a conventional OSD device.

FIGS. 7(a)-7(e) are diagrams for explaining the operation of the OSD device shown in FIG. 6.

FIG. 8 is a block diagram for explaining the construction of another conventional OSD device.

FIGS. 9(a)-9(g) are diagrams for explaining the operation of the OSD device shown in FIG. 8.

FIGS. 10(a)-10(c) are diagrams for explaining the case where an external input signal shown in FIG. 9(c) is lower than the pedestal level.

### DETAILED DESCRIPTION OF THE PREFERRED EMBODIMENTS

### [Embodiment 1]

Hereinafter, a description will be given of an on-screen display (OSD) device according to a first embodiment of the present invention. When a signal having no video sync signal, i.e., a signal in which a horizontal sync signal cannot be distinguished (hereinafter, referred to as a noise signal), is supplied from an input terminal to the OSD device according to this first embodiment, the OSD device superimposes an information signal of characters, graphics, or the like on the noise signal.

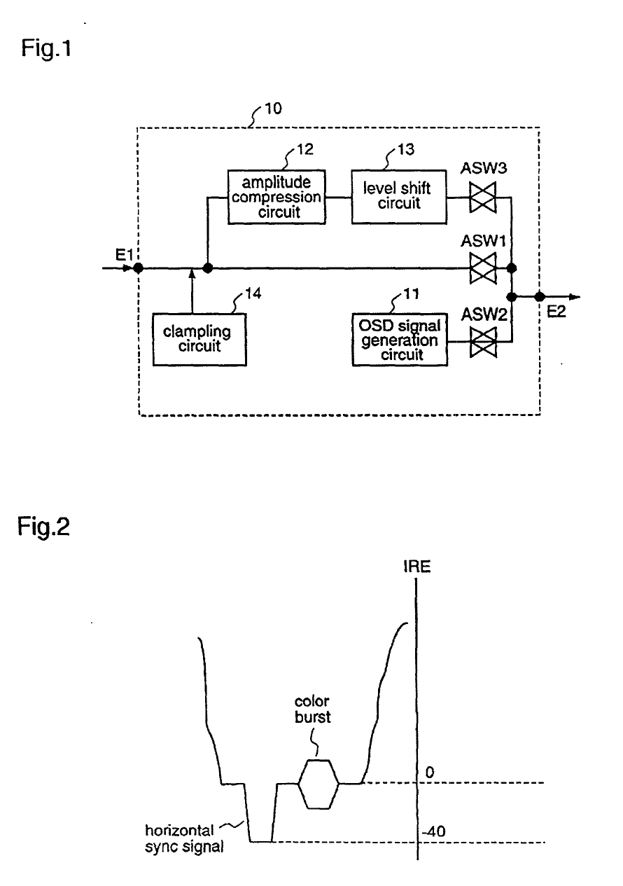

FIG. 1 is a block diagram illustrating an OSD device 10 according to the first embodiment of the present invention.

With reference to FIG. 1, the OSD device 10 is provided with an OSD signal generation circuit 11, an amplitude compression circuit 12, a level shift circuit 13, a clamping circuit 14, and three switches ASW1, ASW2, and ASW3.

The OSD signal generation circuit 11 generates an information signal of characters, graphics, or the like to be displayed on the display screen when external synchronous OSD is carried out, and generates a horizontal sync signal and a color burst signal in addition to the information signal when internal synchronous OSD is carried out. The amplitude compression circuit 12 compresses a signal supplied from an input terminal E1. The level shift circuit 13 varies the DC component of the signal compressed by the amplitude compression circuit 12. The clamping circuit 14 controls the lower level of the input signal. To be specific, the clamping circuit 14 keeps the lower level of the input signal constant without changing the amplitude of the input signal. Especially when the input signal is a noise signal, since the amplitude level of the noise signal is not constant, clamping is carried out to make the pedestal level of the sync signal constant. The switch ASW1 receives the signal supplied from the input terminal E1. The switch ASW2 receives the signal generated in the OSD signal generation circuit 11. The switch ASW3 receives the signal that has boon compressed by the amplitude compression circuit 12 and level-shifted by the level shift circuit 13.

By the way, video signals have been standardized, and there are NTSC (Japan, USA, etc.), PAL (UK, Germany, China, etc.), and SECAM (France, Russia, Eastern Europe, etc.). video equipment makers must follow these standards when outputting video signals.

Hereinafter, an NTSC signal will be described as an example.

In USA, the NTSC signal is defined by the SMPTE (Society of Motion Pictures and Television Engineers) 170M. In Japan, it is defined by the Radio Law, and the RS-170-A standard is the basis thereof. FIG. 2 shows the level of the NTSC signal.

With reference to FIG. 2, 0 ˜−40 (IRE) is the sync signal level. When there is no sync signal, the image displayed on the screen is disordered, and OSD display cannot be performed.

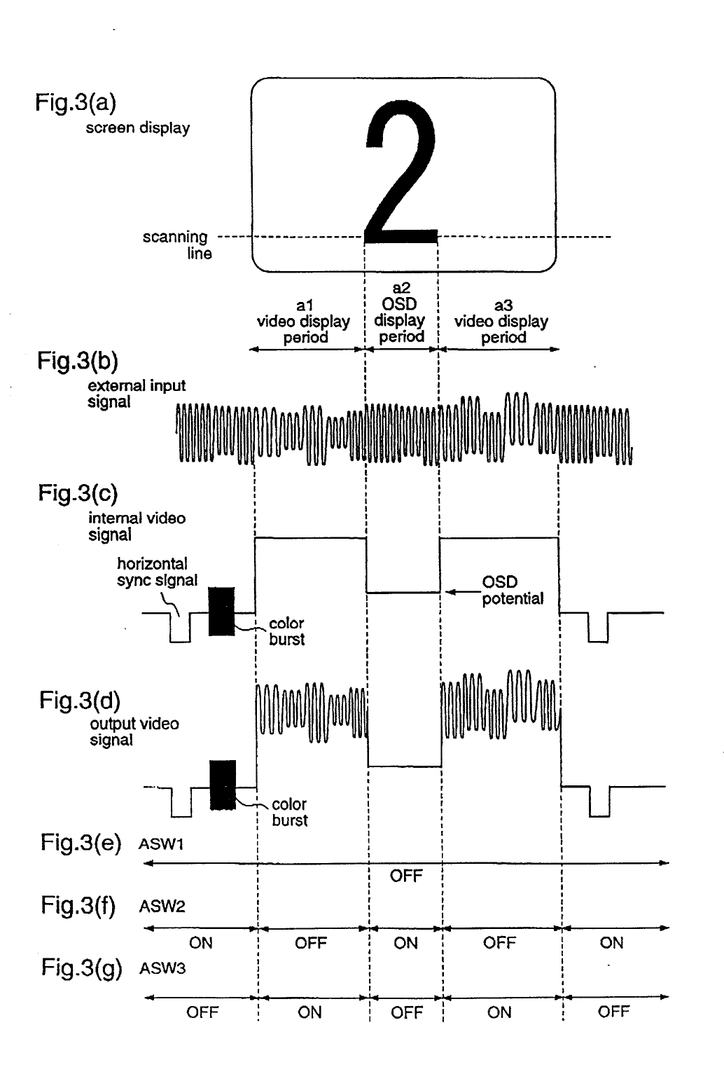

Next, the operation of the OSD device 10 so constructed will be described with reference to FIGS. 3(a)-3(g).

FIGS. 3(a)-3(g) are diagrams for explaining the operation of the OSD device 10 according to the first embodiment. To be specific, FIG. 3(a) shows an example of an on-screen display, FIG. 3(b) shows an external input signal that has been input to the input terminal E1 and then subjected to compression and level-shifting, FIG. 3(c) shows an internal video signal generated by the OSD signal generation circuit 11, FIG. 3(d) shows an output video signal outputted from the output terminal E2, FIG. 3(e) shows the ON/OFF operation of the switch ASW1, FIG. 3(f) shows the ON/OFF operation of the switch ASW2, and FIG. 3(g) shows the ON/OFF operation of the switch ASW3.

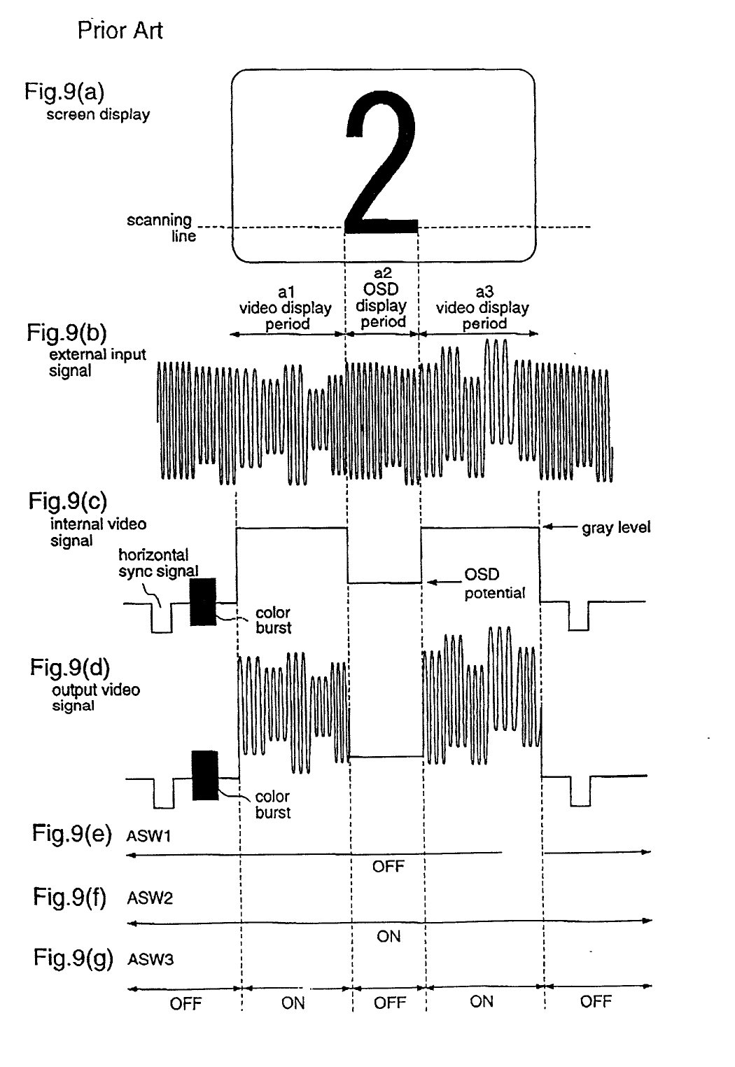

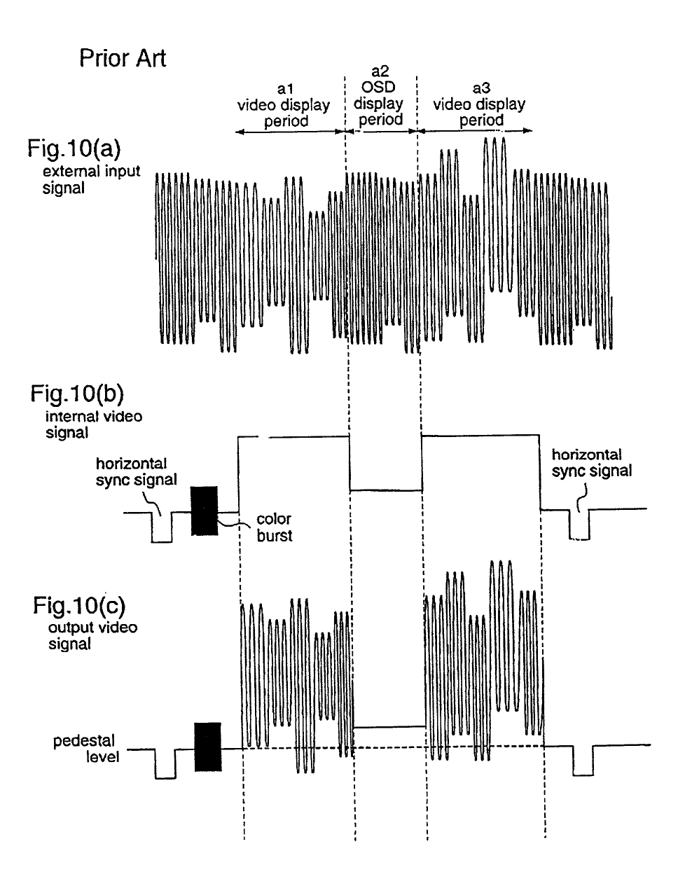

Initially, at the time of external sync OSD, when the noise signal shown in FIG. 9(b) is input to the input terminal E1, the clamping circuit 14 makes the amplitude of the pedestal level constant. Subsequently, the amplitude compression circuit 12 compresses the noise signal such that the noise signal becomes a signal that exists at a level higher than the pedestal level, and then the level shift circuit 13 varies the DC component of the compressed signal to shift the level of the signal such that it exists at a level higher than the pedestal level. The signal outputted from the level shift circuit 13 (first signal) is input to the switch ASW3. This signal is shown in FIG. 3(b).

Next, when the noise signal shown in FIG. 3(d) is input, since the horizontal sync signal and the color burst signal cannot be distinguished from each other in the noise signal, display of the information signal cannot be performed. So, the OSD signal generation circuit 11 generates an internal video signal (FIG. 3(c)) including an information signal (OSD potential), a horizontal sync signal, and a color burst signal.

Next, a description will be given of the operations of the respective switches to display the OSD image and the background image, on the basis of the scanning line shown in FIG. 3(a).

Initially, the switch ASW2 is ON during the OSD display period (a2), and outputs the information signal to the output terminal E2. The switch ASW2 is OFF during the video display period (a1 or a3). Further, the operation of the switch ASW3 depends on the operation of the switch ASW2. That is, the switch ASW3 is OFF when the switch ASW2 is ON, and it is ON when the switch ASW2 is OFF. The switch ASW1 is kept in the OFF state.

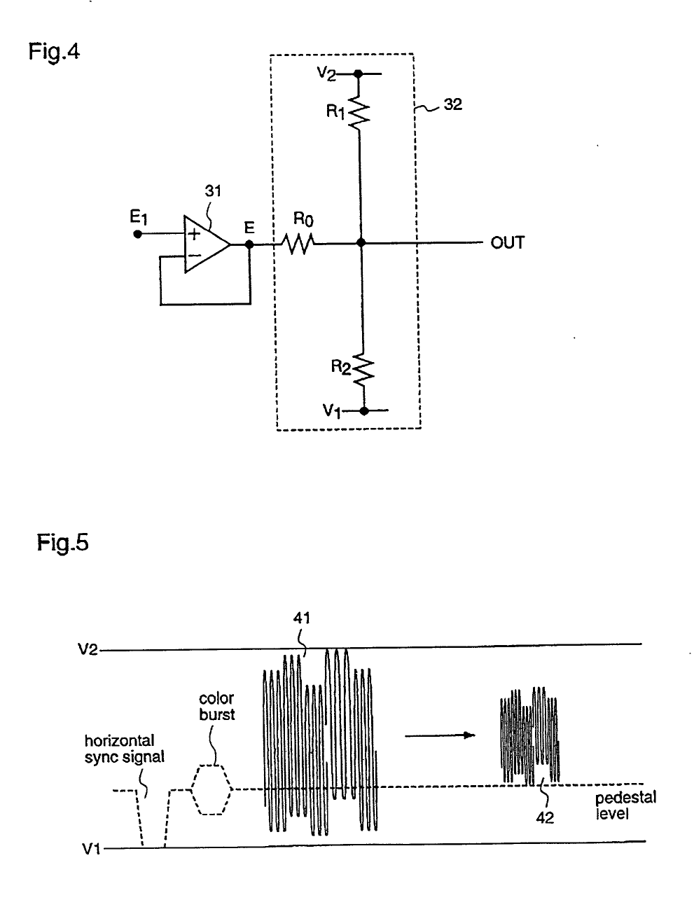

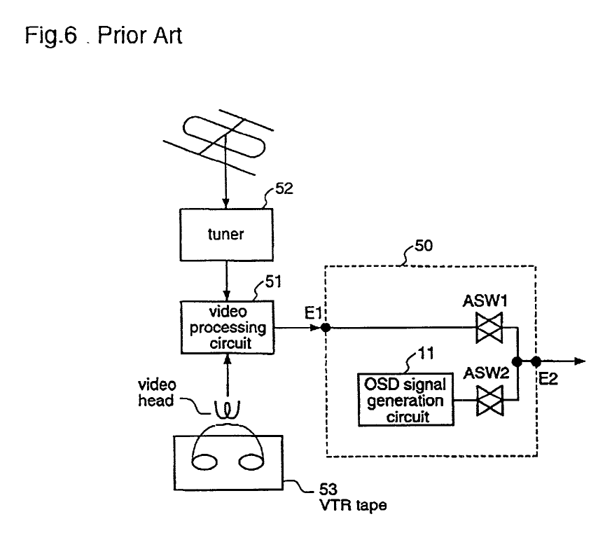

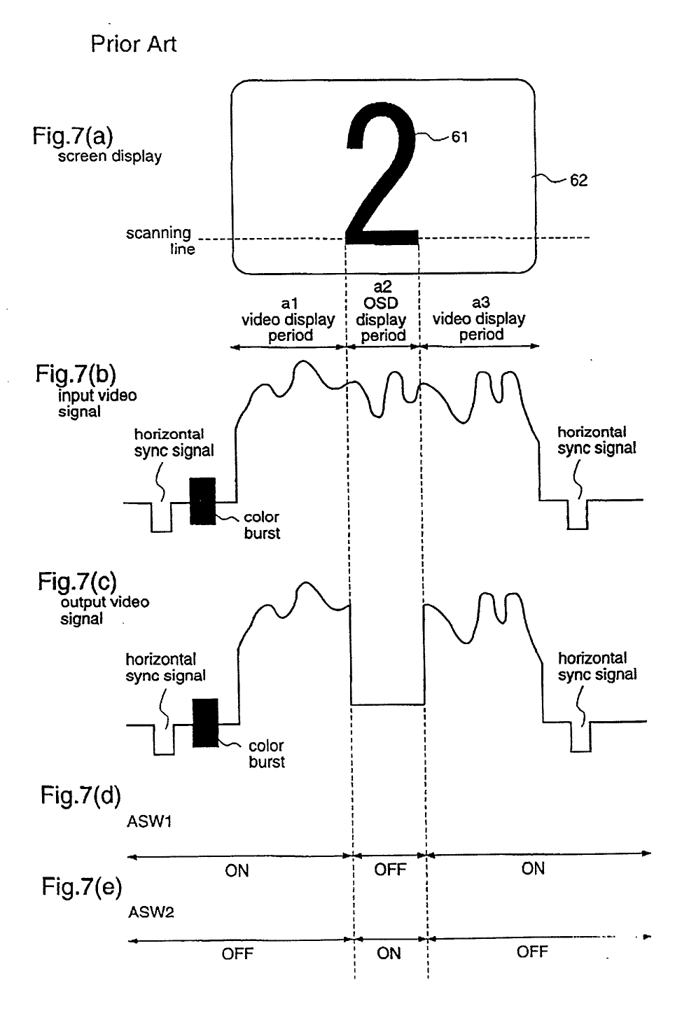

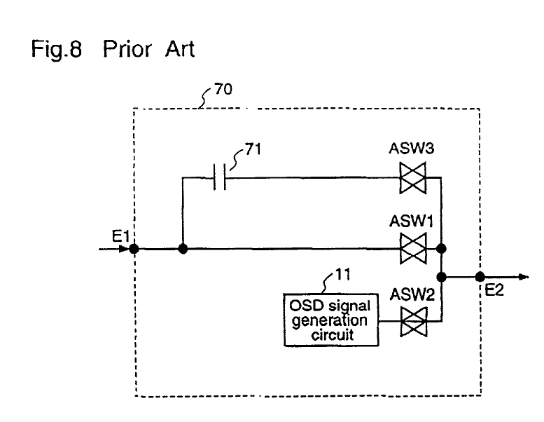

FIG. 4 is a diagram illustrating an amplitude compression/level shift circuit in the OSD device of the first embodiment.

In FIG. 4, an impedance conversion circuit 31 converts the impedance of the external input signal supplied from the input terminal E1. The amplitude compression/level shift circuit 32 (signal conversion means) subjects the impedance-converted signal to amplitude compression and then level shifting. The external input signal supplied from the input terminal E1 is impedance-converted by the impedance conversion circuit 31 and, thereafter, the signal is compressed and level-shifted by the amplitude compression/level shift circuit 32 according to the following formula (1), whereby the amplitude of the signal is prevented from being lower than the pedestal level. Further, the amplitude of noise and the luminance of the display screen can be selected by varying the resistance ratio between R1 and R2 in the amplitude compression/level shift circuit 32. FIG. 5 shows the amplitude-compressed and level-shifted signal.

$$OUT = \frac{ERz + VzR0}{R0 + Rz} [ Vz = \frac{V2R2 + V1R1}{R1 + R2} Rz = \frac{R1R2}{R1 + R2} ] \qquad ( 1 )$$

FIG. 5 is a diagram for explaining an external input signal and a signal that has been subjected to amplitude compression and level shifting, according to the first embodiment.

With reference to FIG. 5, when an external input signal 41 supplied from the input terminal E1 is input to the amplitude compression/level shift circuit 32, a first signal 42 is generated. That is, since the external input signal 41 is subjected to amplitude compression and level shifting, the amplitude of the first signal 42 is not lower than the pedestal level.

In the on-screen display device according to the first embodiment, since the external input signal is subjected to amplitude compression and then amplitude-level shifting, the amplitude level of the external input signal is prevented from becoming lower than the pedestal level, whereby information such as characters can be reliably superimposed on the noise signal. Further, since the resistance of the level shift circuit is variable, the luminance of noise can be arbitrarily changed, whereby information such as characters can be clearly displayed on the display screen.

While in this first embodiment the OSD device 10 is provided with the level shift circuit 13, the level shift circuit 13 may be dispensed with. In this case, the input signal is compressed by the amplitude compression circuit 12 and then outputted to the output terminal E2. Even when the OSD device 10 has no level shift circuit, information such as characters can be reliably superimposed on the noise signal by compressing the amplitude of the noise signal so that the noise signal does not become lower than the pedestal level.

Furthermore, while in this first embodiment the OSD device 10 is provided with the amplitude compression circuit 12, the amplitude compression circuit 12 may be dispensed with. In this case, the input signal is level-shifted by the level shift circuit 13 and then outputted to the output terminal E2. Even when the OSD device 10 has no amplitude compression circuit, information such as characters can be reliably superimposed on the noise signal by shifting the level of the noise signal so that the noise signal does not become lower than the pedestal level.

Furthermore, while in this first embodiment the external input signal is subjected to amplitude compression and then level shifting, level shifting may be carried out prior to signal compression (amplitude compression).

What is claimed is:

1. An on-screen display device comprising:
video signal generation means for generating a video signal including an information signal for displaying information on a display screen, a horizontal sync signal, and a color burst signal;
signal conversion means for compressing the amplitude of an input signal so that the input signal can exist at a level higher than the level of the horizontal sync signal, and shifting the level of the input signal so that the input signal can exist at a level hither than the level of the horizontal sync signal, thereby generating a first signal; and
output control means for outputting the video signal when the information signal is displayed on the display screen, and outputting the first signal when the information signal is not displayed.

2. The on-screen display device of claim 1, wherein said signal conversion means comprises:
signal compression means for compressing the amplitude of the input signal so that the input signal can exist at a level higher than the level of the horizontal sync signal; and
level shift means for shifting the level of the input signal so that the input signal can exist at a level higher than the level of the horizontal sync signal.

3. An on-screen display device comprising:
video signal generation means for generating a video signal including an information signal for displaying information on a display screen, a horizontal sync signal, and a color burst signal;
signal compression means for compressing the amplitude of an input signal so that tho input signal can exist at a level higher than the level of the horizontal sync signal, thereby generating a first signal; and
output control means for outputting the video signal when the information signal is displayed on the display screen, and outputting the first signal when the information signal is not displayed.

4. An on-screen display device comprising:
video signal generation means for generating a video signal including an information signal for displaying information on a display screen, a horizontal sync signal, and a color burst signal;
level shift means for shifting the level of the input signal so that the input signal can exist at a level higher than the level of the horizontal sync signal, thereby generating a first signal; and
output control means for outputting the video signal when the information signal is displayed on the display screen, and outputting the first signal when the information signal is not displayed.
